(19) United States
(12) Patent Application Publication
(10) Pub. No.: US 2008/0319812 A1
(43) Pub. Date: Dec. 25, 2008

(54) SUSTAINABLE DESIGN DECISION SUPPORT SYSTEM

(75) Inventors: Maria Ines Silva Sousa, San Francisco, CA (US); Terry Swack, Brookline, MA (US); Brian Sanders, Boston, MA (US); Greg Canavera, Cambridge, MA (US); Philip White, Phoenix, AZ (US); Hugh Keith Lehman, Lexington, MA (US)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(73) Assignee: Sustainable Minds, LLC, Brookline, MA (US)

(21) Appl. No.: 12/123,211

(22) Filed: May 19, 2008

Related U.S. Application Data
(60) Provisional application No. 60/938,800, filed on May 18, 2007.

(51) Int. Cl. G06Q 10/00; G06Q 99/00

(52) U.S. Cl. 705/7; 705/1

(57) ABSTRACT

A software application providing system and methods for using Web Services to connect an Analysis calculator, a Recommendations engine, Social Networking, and Knowledge Management technologies in a platform for operationalizing sustainability into Product Life Cycle Management (e.g., conception, design, manufacture, service, end-of-life disposition) and Enterprise Resource Planning (ERP) (including enterprise-wide activities of manufacturing, supply change management, financials, human resources, customer relationship management, and external stakeholder engagement). A Web Service Framework integrates Life Cycle Assessment (LCA) software technology with product design, manufacturing, and distribution process design tools. A logic layer can perform sustainability estimates within a Knowledge Management System. A Web Service Framework is utilized for constructing or entering LCA models, methodologies and source data. A social software-based participation environment is integrated with sustainable product design and LCA tools and processes.

### FIELD OF THE INVENTION

This Invention relates generally to the fields of Environmental Sciences and Modeling, Sustainable Development, Product Design, Artificial Intelligence, Knowledge Management and Social Network Systems. More specifically, the invention relates to a Web-based system that provides sustainable design decision support and information services in a collaborative environment enabling product design teams to operationalize Sustainability and create innovative ‘green’ products.

### BACKGROUND

A growing demand for accountability and transparency is driving sustainable business practices, changing the way many companies design products. Key drivers include:

1. Environmental pressures. Climate change, energy, water, human health and ecological toxicity, and unknown emerging environmental risks are major challenges. Companies both large and small will be required to address them—be aware of the big issues, understand where the science stands and know where the impacts occur in the life cycle of their products.

2. Emerging stakeholders or stakeholders' strategies and actions. Rule-makers and watchdogs: new governmental regulations have been reshaping the competitive playing field such as the European Commission (EC) directives Restriction of Hazardous Substances (RoHS) and Waste Electrical and Electronic Equipment (WEEE), affecting not only European companies but any company selling products in the European Union (EU) must also comply. With one third of global electronic sales in the EU, these directives have affected the global tech industry, from well-known brands to the many large and small firms in their outsourced supply chains. But these directives will have implications for most companies, not just those in the information technologies (IT) and consumer electronics industries. These regulations encourage value chain or life cycle thinking by imposing a real cost on companies that do not design products in accordance with the restrictions or the end of life consequences in mind.

Business partners, competitors, suppliers and B2B customers: business-to-business customers requiring suppliers to disclose how they make and precisely what's in their products.

Consumers and community (e.g., corporate social responsibility [CSR]): consumers who want to know what's in the products they buy and how safe they are for themselves, their children, and the environment; employees who want to find out what their companies stand for to match their personal and professional values.

Investors and risk assessors: banks are increasingly factoring environmental and social variables into their loan decisions; insurance companies are incorporating into their policies environmental risks as business threats; stock market analysts view environmental performance as an indicator of management quality.

Idea generators and opinion leaders (media, think tanks and academics) continue to define sustainability objectives—defining new metrics and raising the standards of what it means to be more sustainable.

3. New drivers for long-term business success—competitive advantage is accomplished by:

Managing the cost and risk: cut operational and environmental costs (e.g. waste handling and regulatory burdens) throughout the value chain and product life cycle; identify and reduce environmental and regulatory risks in operations, particularly in supply chains to avoid costs, reduce time to market, and ensure continued supply.

Managing revenues and intangibles: uncover new market spaces to drive new revenues by designing and marketing products that are innovative, environmentally superior and meet customer needs; create intangible value by credibly marketing overall corporate social and environmental responsibility and practices.

These key drivers generally require whole system approaches and sustainable mindsets fostered, adopted and incorporated at early conceptual product design stages. In general, some companies are setting operational sustainability goals beyond regulatory compliance, but fail to apply them to the design and manufacture of their products. Some marketers are struggling with how to meaningfully promote the ‘green’ attributes of the products they are promoting. Product design teams are often being asked to assess the overall life cycle environmental and social impacts of the products they are developing during evaluation of concept feasibility in order to understand how design changes can affect the life cycle performance of a product during evaluation of concept feasibility and uncover new opportunities for innovation.

Life Cycle Assessment (LCA) is the principle means by which people attempt to assess the environmental character—the ‘greenness’—of products and materials throughout their life cycle. In general, however, the cost, time and expertise required to conduct full-scale LCAs can be beyond the reach and practical usefulness of most product teams and may not be used for loosely defined or rapidly evolving product concepts at early design stages.

Therefore, a need exists for a system that can provide sustainable design decision support and information services in a timely and cost effective manner.

### SUMMARY

In general, in an aspect, the invention provides a method for providing sustainability information and design strategies to a user in a collaborative environment over the world wide web.

In general, in another aspect, the invention can be a system for providing sustainability information and design strategies to a user, including a user interface component that can receive a planned product design and a specified life cycle assessment methodology, a product design assessment component that can evaluate the planned product design based on the specified life cycle assessment methodology, a recommendations component that can provide at least one material to be used in the planned product design based on the results of the product design assessment, and a product design comparison component that can compare the results of the product design assessment with results of at least one other product design assessment.

Implementations of the invention may include one or more of the following features. A knowledge management component can share sustainable product design information with a plurality of users. A knowledge management component can share at least one case study. The recommendations component can provide at least one sustainable design strategy that could be used in the planned product design based on the results of the product design assessment. An expert user interface component that can receive expert information. A planned product design received from the user can include at least one material type and an amount of the material type. The knowledge management component can share at least one product design assessment. The knowledge management component can share at least one sustainable design strategy. The specified life cycle assessment methodology can be Okala.

In general, in another aspect, in invention provides a computer-readable medium having computer-executable instructions for providing sustainability information, including maintaining a database identifying product materials and processes and their corresponding alternative materials and processes, receiving at least one design goal from a user, receiving a bill-of-materials including at least one product material and an amount of the at least one product material, calculating at least one life cycle assessment result based on the at least the bill-of-materials and using at least one specified life cycle assessment methodology, recommending at least one alternative material based on the life cycle assessment results and the bill-of-materials, and displaying the life cycle assessment results and the at least one alternative material.

Implementations of the invention may include one or more of the following features. Maintaining a database of sustainable design strategy recommendations, and displaying at least one sustainable design strategy recommendation based on the at least one design goal and the at least one life cycle assessment result. Maintaining a database of best practices, and displaying at least one best practice based on the at least one product material and the at least one life cycle assessment result. Maintaining a collection of case studies, and displaying a case study based on the at least one design goal, at least one design strategy, and the at least one life cycle assessment result. The life cycle assessment result can be based on Okala.

In general, in another aspect, the invention provides a computer system for providing sustainability information, including at least one storage device, at least one processor programmed to provide a graphic user interface configured to receive product information from a user, a LCA calculator configured to analyze the product information and determine a life cycle assessment result, a recommendation engine configured to analyze the product information and the life cycle assessment result, and to determine a sustainable design strategy, a knowledge management database identifying the sustainable design strategy and a corresponding implementation note, and a social networking system configured to display a case study on the graphic user interface based on the product information and the life cycle assessment result.

Implementations of the invention may include one or more of the following features. At least one processor can be programmed to provide an expert user interface. More than one processor can be on a network. At least one processor can be programmed to provide a machine-to-machine programmers interface as an alternative method to the graphical user interface for obtaining product information from a user. At least one processor can be programmed to provide a machine-to-machine programmers interface as an alternative method to reporting the LCA results and recommendations from the LCA calculator, the knowledge management component and the recommendation component. The social networking system can be configured to display an email address of an individual based on the product information and the life cycle assessment result. The social networking system can be configured to display at least one previously stored project based on the product information and the life cycle assessment result.

In accordance with implementations of the invention, one or more of the following capabilities may be provided. Sustainable product designs can be realized. For example, a Goal setting and iterative life cycle-based product design assessment tool can be used to enable informed eco goal-setting and rapid, iterative evaluations in the conceptual design stage to perform ‘what if’ analysis, validate design options and connect design decisions with business goals. A rich reporting and data visualization can be used to interpret and communicate design assessment results. A recommendation/optimization engine can be used to provide alternative materials, process and design strategies recommendations. A knowledge management system in a collaborative workspace can be used to develop, collect, and share sustainable product design knowledge across an organization and in the public space, and a software-based social networking participation environment can be used to document institutional and community knowledge, including discussions, blogs, shared bookmarks, tagging, content rating, searching, RSS feeds, file-sharing, comparisons, and versioning. An information & education services data system can be used to access best-in-class information, support and training from top sustainability industry experts and trusted sources about strategies and approaches, processes, products, materials, best practices, benchmarks, regulatory requirements, sustainability metrics, including community generated case studies and industry-specific content.

In operation, implementations of the invention can provide tools to enable sustainable product designs. For example, at early design stages, decisions are made such as materials used, material sources, manufacturing processes used, energy requirements, recycleability and longevity, which ultimately determine a product's life cycle performance. These decisions are often locked-in early because of the resources (time, manpower, and money) needed to make changes as product launch deadlines approach. Therefore, it is preferable to bring environmental and social considerations to the front of the design process and use them in the evaluation of concept feasibility along with other requirements, such as operational performance and price. Product design teams can evaluate the approximate environmental performance of alternative concepts and devise design improvement strategies early in the design process. Different concept ideas, and multi-attribute tradeoffs and decisions can be made quickly through information and knowledge exchange. Sustainable life cycle thinking is brought to the beginning of the design process and can be used as a lens through which all design and development projects are viewed.

These and other capabilities of the invention, along with the invention itself, will be more fully understood after a review of the following figures, detailed description, and claims.

### BRIEF DESCRIPTION OF THE FIGURES

FIG. 1 is a conceptual diagram of the overall product life cycle.

FIG. 2 is an exemplary architectural diagram of a Sustainable Design Decision Support System.

FIGS. 3A-3C is an exemplary user interface for creating a new product project.

FIG. 4A is an exemplary user interface for summarizing and comparing Life Cycle Assessment results with a reference product.

FIG. 4B is an exemplary user interface for comparing, by product component, life cycle greenhouse gases impact results with a reference product.

FIG. 5A is an exemplary user interface for comparing, by product component, life cycle impact results with a reference product.

FIG. 5B is an exemplary user interface for comparing, by product component, impact categories results with a reference product.

FIG. 6A is an exemplary user interface for comparing, by life cycle phase, impact categories results with a reference product.

FIG. 6B is an exemplary user interface for comparing system Bill-of-Materials data and Life Cycle Assessment results with a reference product.

FIG. 7 is an exemplary user interface for a team collaborative workspace and a social network.

FIG. 8 is an exemplary flowchart of a sustainable product design process utilizing the Sustainable Design Decision Support System.

### DETAILED DESCRIPTION OF PREFERRED EMBODIMENTS

Embodiments of the invention provide a system and methods for connecting Analysis, Artificial Intelligence, Social Networking, and Knowledge Management technologies to create a platform for operationalizing Sustainability into Product Life Cycle Management (e.g., product conception, design, manufacture, service and end-of-life disposition) and Enterprise Resource Planning (ERP) (including enterprise-wide activities of manufacturing, supply chain management, financials, human resources, customer relationship management, and external stakeholder engagement). A web services framework integrates Life Cycle Assessment (LCA) software technology with existing product design, manufacturing planning, product data management, supply chain management, financial planning, and distribution management tools. An LCA calculator applies embedded sustainability factors to the design variables and provides the associated results. An Artificial Intelligence (AI) recommendations engine enables LCA estimates with a Knowledge Management System. A web services framework is utilized for constructing or entering LCA models, methodologies and data. A case based reasoning, or expert system, and categorization systems can also be used to construct or select LCA models and methodologies. A software-based social networking and participation environment is integrated with sustainable product design and LCA tools and processes. The system is capable of supporting both rich client and Software as a Service (SaaS) delivery models, as well as being cloned and distributed into proprietary networks. The system instructions can be stored in a computer readable medium in a computer readable memory, such as conventional hard disks, CD-ROM, DVDs, Flash ROMS, nonvolatile ROM, and RAM. This system is exemplary, however, and not limiting of the invention as other implementations in accordance with the disclosure are possible.

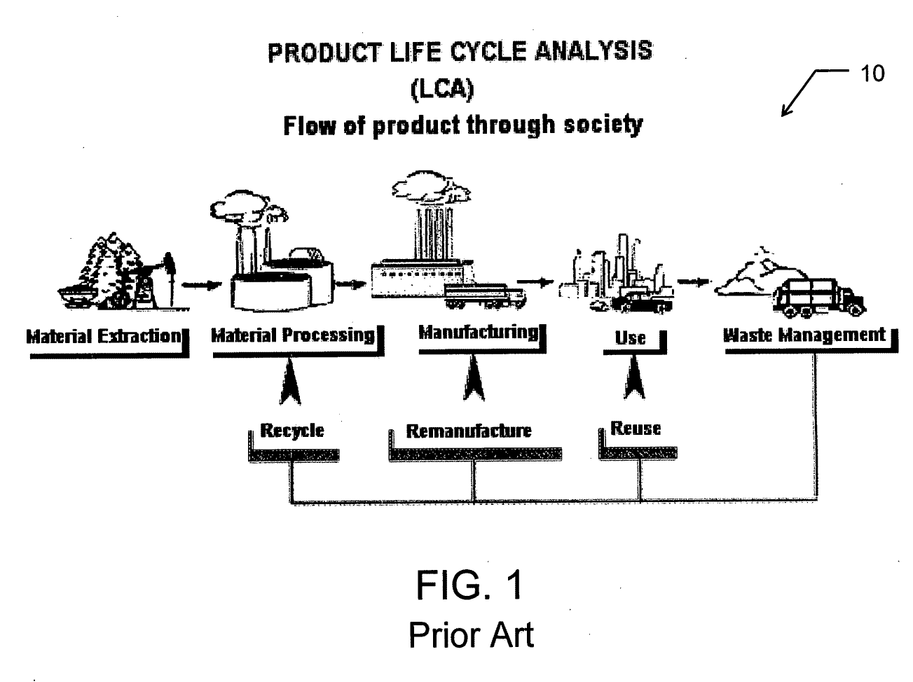

Referring to FIG. 1, a conceptual diagram of the overall product life cycle 10 is shown. Life Cycle Assessment (LCA) is a tool to evaluate the environmental and human health burdens associated with a product, process, or activity by identifying energy, materials used and emissions released into the environment, from raw material extraction to final product disposition, and evaluating the potential environmental and human health impacts associated with the identified energy and material inputs and releases. For example, a corporation may use LCA to assess the benefits of introducing an innovative product, to benchmark existing products for continuous improvement, and to communicate superior environmental performance. A governing body may use LCA to influence policy and establish guidelines for environmentally preferable purchasing. Non-governmental organizations and industry consortiums may use LCA to standardize reporting of performance measures through environmental product declaration programs.

LCA can be implemented at various stages of product design. However, to increase the value and probability of success, product design professionals generally need to acquire new knowledge of LCA trends, as well as use new processes and tools to aid in designing sustainable products. As will be discussed, the proposed Sustainable Design Decision Support System can assist design professionals to acquire the knowledge. For example, the Sustainable Design Decision Support System will enable improved access to the latest information about processes, products, materials, best practices, regulatory requirements, and sustainability metrics; share proprietary models and knowledge across the network to document work for a client, learn from the acquired knowledge, use it in the future, and benchmark after manufacturing to verify accuracy; and provide tools and processes that enable design professionals to become more effective and knowledgeable about Sustainability.

In general, the proposed Sustainable Design Decision Support System can enable design teams to bring sustainability and life cycle thinking to the front of the design process. As a Web-based software application, it empowers design teams without the need for external consults. Product designers, design engineers, product managers or sustainability managers can quickly integrate sustainable design methods and knowledge into their work, and to continuously learn while doing.

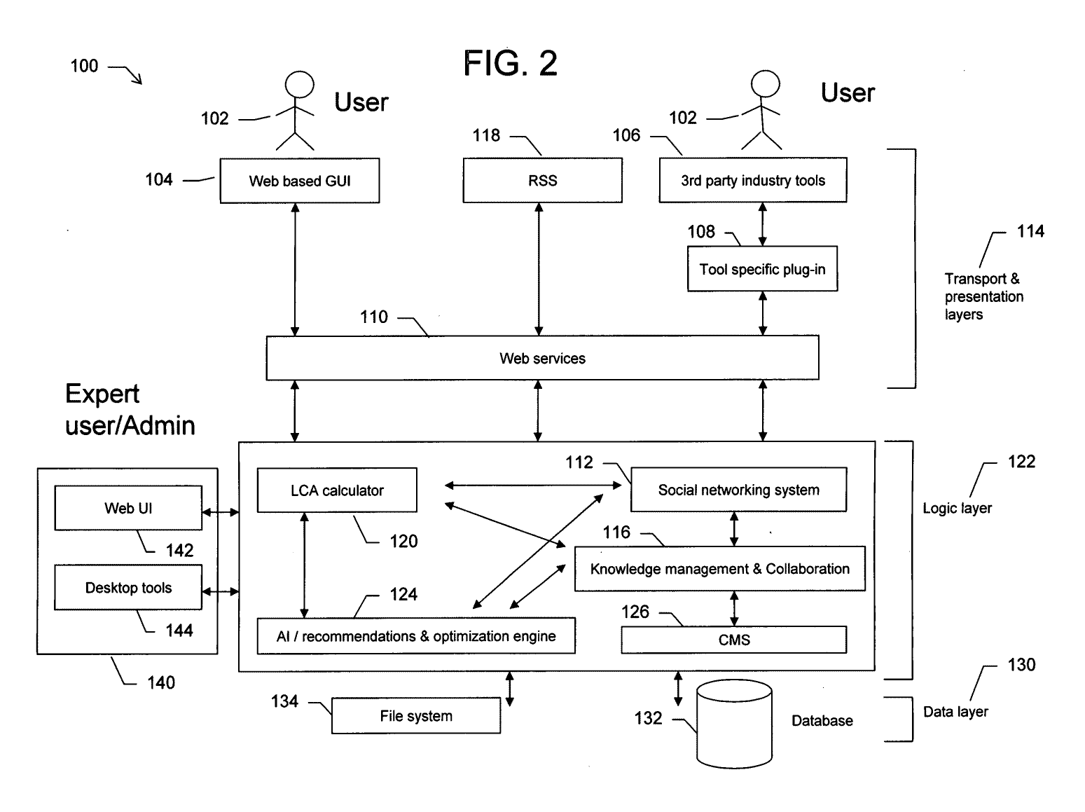

Referring to FIG. 2, a Sustainable Design Decision Support System 100 is shown. The system 100 includes users 102, transport and presentation layers 114, at least one logic layer 122, and at least one data layer 130. The layers 114, 122, 130 are operably connected and can be contained within a single processor, memory and data storage device (e.g., a server, personal computer). The layers 114, 122, 130 can also be configured on different servers or computers across a network (e.g., LAN, WAN, Internet). In an embodiment, the data layer 130 can include at least one database 132 and a file system 134. In general, in an embodiment, the transport and presentation layers 114 provide and receive information from users 102 via, a Web GUI 104, at least one 3^{rd} party industry tool 106 and associated tool specific plug-in 108, a Web services layer 110, and a RSS feed 118.

In general, the user interface 104 is configured to run on an Internet browser or in a Desktop environment (e.g. Adobe Air™) with a framework which incorporates text based formats such as HTML, DHTML, as well as multimedia technologies including Adobe® Flash® (e.g., such as authored in Adobe® FLEX® framework). The UI 104 can be configured to run over the internet, or behind a client firewall (e.g., within a closed network) based on a company's security requirements. The UI 104 is configured to receive concept, product and goal information from a user 102 and graphically display sustainability information such as life cycle assessment results, side-by-side comparisons with other products and concepts, material and process recommendations, design strategies and case studies. The UI 104, in combination with the logic layer 122 and data layer 130, can be configured to recalculate and redisplay new sustainability information as a user 102 iterates through changes in concept, product, or goal information.

In general, the logic layer 122 can include a social networking system 112, a knowledge management and collaboration system 116, an LCA calculator 120, an AI/recommendation and optimization engine 124, and a content management system (CMS) 126. In operation, the users 102 are using the system 100 to answer direct LCA questions and perform LCA-centric “what if” scenarios in an effort to design their products more sustainably. The users 102 can access the system 100 through either a rich GUI 104 (e.g., a Rich Internet Application), or via a third-party tool 106 (e.g., a CAD tool such as SolidWorks®, a PDM tool, or other PLM and ERP tools) with a tool specific plug-in 108. Both the UI 104 and third-party tools 106 are connected to a web services 110 (i.e., a web services API). The web services 110 can include XML services such as provided by J2EE, Microsoft.net®, PHP or other SOAP data format over HTTP. In an embodiment, the web services layer 110 can provide access into the other logic layer 122, with the corresponding applications such as the social networking system 112, the knowledge management system 116, the LCA calculator 120, and the recommendations engine 124. Other system layers or modules, such as a business logic layer, may also be included within the system 100. The social networking system 112, and the knowledge management system 116 may include both proprietary and open source programs (e.g., Drupal, Fast Search, third-party Wiki tools, PBWiki, Basecamp and bulletin board systems).

The logic layer 122 can be configured to receive company, concept, product and design information from the user 102 via the U1 104 or the 3^{rd} party tools 106 interface. The LCA calculator 120 can be configured to process this information and return a sustainability analysis. For example, the LCA calculator 120 can receive product information from a bill-of-materials (BOM) that can include material types (i.e., name of the material), volume or amount of materials used, and the units, manufacturing processes and additional product system information, such as transportation mode and distances and energy use estimates. The LCA calculator 120 can output, for example, a single Okala LCA score as well as Okala LCA scores by impact categories (Okala is a North American life cycle impact assessment methodology). The BOM information can be keyed in by the user 102 or can be received directly from PDM or other product design or management software. In an embodiment, the 3^{rd} party tool 106 can be configured to run the analysis directly from within the third party system. For example, a design environment such as SolidWorks® can be configured to include a “Green It” button which will activate the logic layer 122 to display sustainability information based on the data contained within a SolidWorks® model.

The web services layer 110 can also include at least one processor programmed with a machine-to-machine programmer's interface (Web Services API). This API can be proprietary or based on industry standard protocols, such as SOAP. The company or third party developers can program a tool specific plug-in 108 to use the Web Services API to communicate over a network with the web services layer 110. The web services layer 110, the third party tool 106, and the tool specific plug-in 108 can then provide an alternative method to the graphical user interface for obtaining product information from a user. The web services layer 110 can then also communicate with the third party tool 106 to report the LCA results and recommendations from the LCA calculator, the knowledge management component, the recommendation component, and the social networking component

The AI/recommendations and optimization engine 124 is configured to send and receive information to and from the LCA calculator 120. In an embodiment, the recommendation engine 124 includes rules and information about materials and their impact on the environment. For example, the recommendation engine 124 can receive the LCA score from the LCA calculator 120 and output a list of alternative materials and amounts and design strategies that can be used in the design. In general, the recommendation engine 124 is a rules based engine atop of a database. The rules engine can exist within the logic layer 122 and the data can be included in the data layer 130. The rules data used by the recommendation engine 124 can be modified via an expert user/administration interface 140. The interface can include a web UI 142 and desktop tools 144 for adding, updating and generally maintaining the elements of the logic and data layers 122, 130.

As an example, and not a limitation, in another embodiment, LCA calculator 120 includes a sequence of questions to be answered by a user 102, wherein the answers are processed by the recommendations engine 124 to determine the sustainability information (i.e., coefficients). In another embodiment, the logic layer 122 includes a plurality of LCA calculators 120 which are configured to implement more than one LCA methodology.

In an embodiment, the AI/recommendation engine 124 can further include a neural network, an expert system, a case-based reasoning model, a categorization engine, and mathematical models. These components of the AI module 124 can be conceptual abstractions that generally represent AI functions. For example, a neural network and mathematical models can perform modeling functions that receive a collection of inputs, perform a computational algorithm, and produce an output with LCA results and other sustainability information. The AI/recommendation and optimization engine 124 can be configured to process full text data sets. In general, the engine 124 can automatically search a text document such as an MSWord® or PDF document and determine a set of categories within the document.

In operation, the Sustainable Design Decision Support System provides Web 2.0 platform capabilities for delivering knowledge and tools to product design and development teams (i.e., users 102) to create innovative and sustainable products. The Sustainable Design Decision Support System 100 provides news, information, best practices, case studies, and heuristics on life-cycle thinking. The social networking system 112 can provide information and education services to educate the users 102 about sustainability, building sustainable products and how the system 100 operates. For example, the recommendation engine 124 may provide the user 102 with a suggested substitute material to use in a design. In general, the substitute material can be more environmentally friendly than the original material. The social networking system 112 can include information about the material, as well as how to substitute the material. In an embodiment, the social networking system 112 can store a collection of case studies which can be indexed by life cycle assessments results and other product information. Further, the social network can include contact information (e.g., names, web sites, and email addresses) of other individuals who have worked on similar products or projects. In operation, the recommendation engine 124 can include links to the social networking system 112, and provide those links based on the design analysis. In general, the social networking system 112 can aggregate appropriate news and information regarding sustainable product design and manufacturing including new products, methods, evaluation systems and regulations. The knowledge management and collaboration system 116 can provide a collaborative environment to allow teams and individual users to work on, for example, products and concepts, and to share such information with other users on a selected network. For example, the KM system 116 can allow users within a company to share product information across the company such that users in a company can perform sustainability analysis at the component level. The information for these components can be included in a larger system design. The KM system 116 can facilitate organization of sustainability data based on product components. The KM system 116 can also include a collection of implementation notes to provide users with information on how to implement a new material or sustainable design strategy.

The Sustainable Design Decision Support System 100 further assists the users 102 by providing case studies which can be used early in the design process to investigate and validate design options. A goal of the system 100 is to allow users 102 to better relate design changes with approximate environmental and social performances. A case study can include the product and sustainability information entered by a user 102, the LCA information or results, and the recommendations provided by engine 124. A case study can reside within the KM system 116, or can be published to the social networking system 112. The social network 112 can also be configured to store other product projects for future reference. The projects can be indexed by general product information (e.g., materials, use, applications), as well as other life cycle assessment results (e.g., single number, material recommendations, impacts). Access to a particular case study can be limited to groups of users, or it can be made available to wide areas of the network. Case study information, as well as other material within the KM and social networks 116, 112 can be sent to third party applications for subsequent review by a user. The system 100 can include a machine-to-machine programmers interface to facilitate the transmission of knowledge management information, recommendations, and social network data to third party applications.

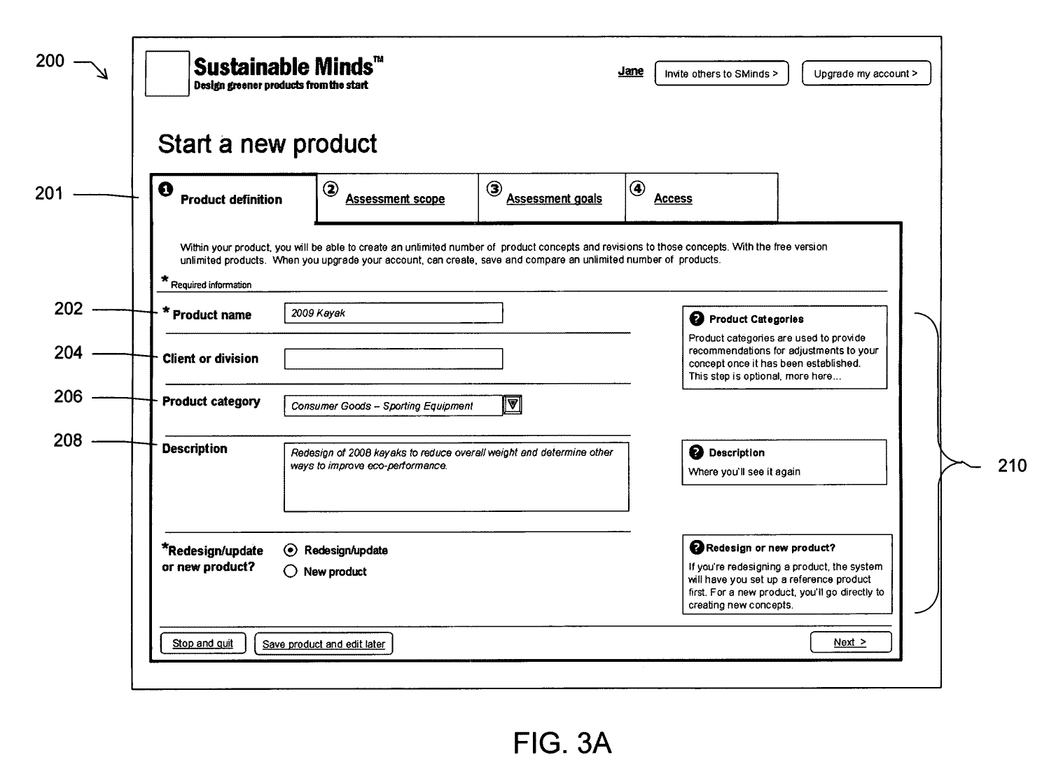

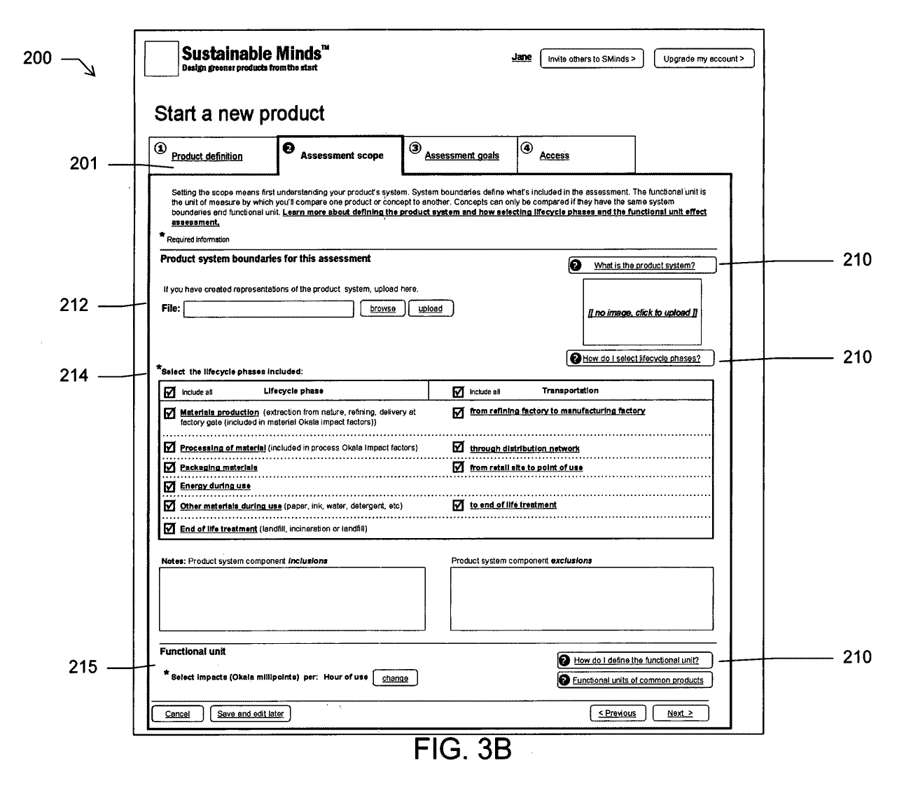

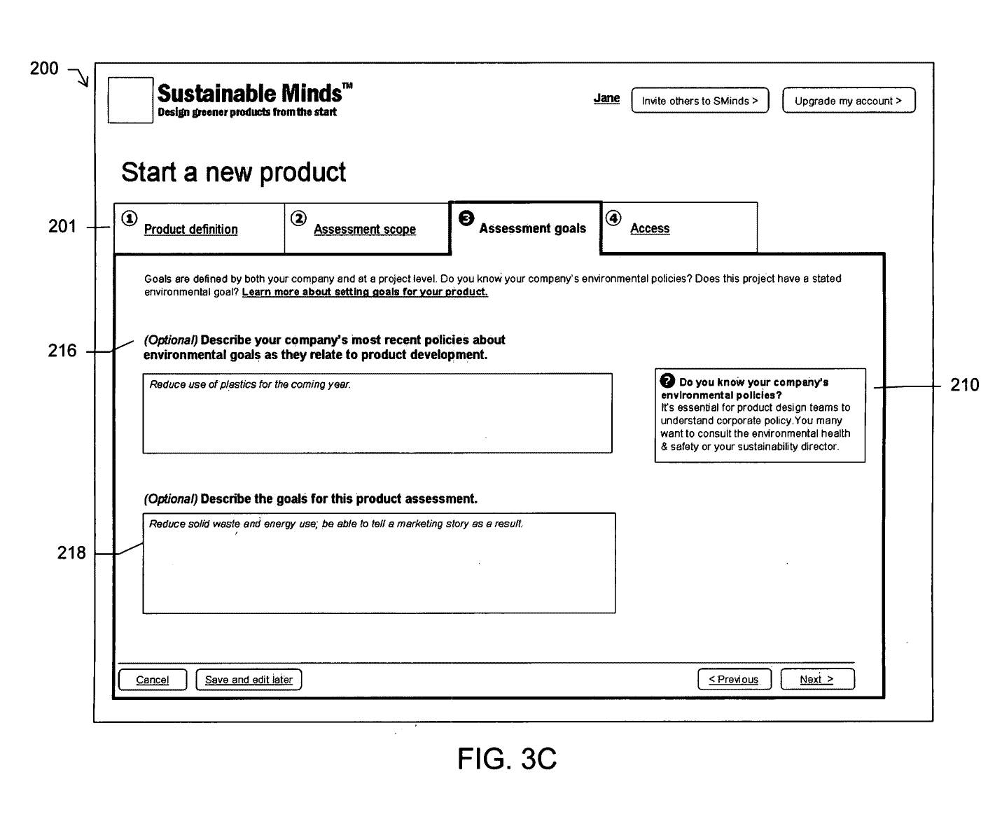

Referring to FIGS. 3A-3C, with further reference to FIG. 2, an exemplary user interface for creating a new product project 200 is shown. In general, the user interface 104 (i.e., a GUI) includes a collection of data input and display objects as known in the art. As an example, and not limitation, the user interface 104 can include a series of screens for creating a new product project. Referring to FIG. 3A, the UI screens 200 can include tab objects 201 configured to present data objects relating to product definition, assessment scope, assessment goals, and access. For example, the product definition tab can include data fields for a product name 202, a client or division 204, a product category 206, and a text box for description 208. Within the user interface 104 the data fields can include text boxes, list boxes, combination boxes, radio buttons and other GUI objects as known in the art. The “Start a new product screens” 200 may also include topical help fields 210 which can correspond to the data fields to facilitate data entry by the user 102. Referring to FIG. 3B, a user 102 can select the assessment scope tab 201. In general, setting the assessment scope includes establishing system boundaries for the assessment. The boundaries can be stored as a file and selected via the representations data field 212. The user 102 may also select lifecycle phases and transportation elements to be included in the assessment. Examples include materials production (e.g., extraction from nature, refining, and delivery at factory gate), processing of material, packaging materials, energy consumption during use, other materials during use, and end-of-life scenarios. Transportation elements can include, for example, the transportation from refining factory to manufacturing factory, transportation through distribution networks, transportation from retail site to point of use, and transportation to end-of-life destination. The user 102 may also indicate the functional unit (e.g., Okala millipoints per hour of use) to be used in the assessment 215. Referring to FIG. 3C, the user 102 can enter assessment goals. In general, the goals are defined by a company and can be entered via a text box 216. For example the goals may include the company's environmental goals as they relate to product development such as increase recycling or eliminate hazardous materials. Goals may also be assigned for a particular product assessment, such as reducing energy consumption during use or increase energy efficiency associated with the product 218. Goal-setting may also be tied to regulatory and industry standards compliance as well as third party certification systems and criteria.

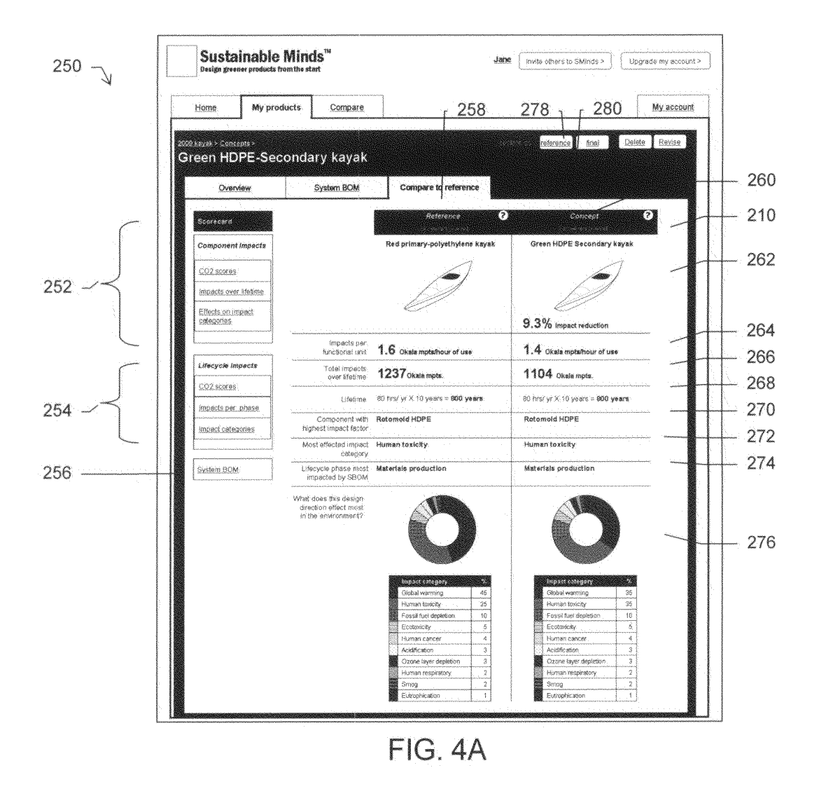

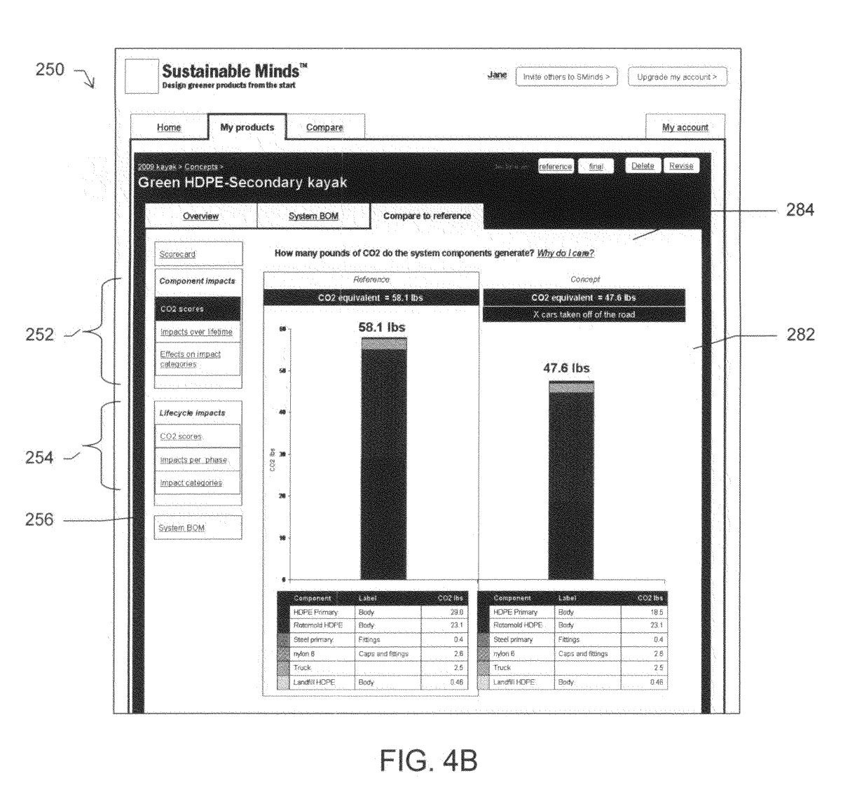

Referring to FIGS. 4A and 4B, an exemplary user interface for comparing lifecycle assessment results 250 is shown. The UI can include component impact navigation buttons 252, lifecycle impact navigation buttons 254, and a system BOM navigation button 256. In general, the navigation buttons 252, 254, and 256 are configured to present graphical representations of different LCA results comparisons between a current concept of a product and previously saved reference products. For example, the component impacts 252 can include CO2 scores, impacts over lifetime, and effects on impact categories. The lifecycle impacts 254 can include CO2 scores, impacts per phase, and impact categories. The graphical display 250 generally presents a concept of a product as compared to a known reference product 260, 258. In an embodiment, the comparison can include images of the product and the reference with an impact reduction percent (%) 262, the respective impacts per functional unit 264 (e.g., Okala millipoints/hour of use), the respective total impacts over the product lifetime 266, an estimated lifetime 268, the component with the highest impact factor 270 (e.g., Rotomold HDPE), the most affected impact category 272 (e.g., human toxicity), and the lifecycle phase most impacted by the System Bill Of Materials (SBOM) 274. The assessment can also include a graphical representation 276 depicting the relative impact categories, such as, global warming, human toxicity, fossil fuel depletion, eco-toxicity, human cancer, acidification, ozone layer depletion, human respiratory, smog, and eutrophication. A concept of a product 260 can be stored as a final concept via an action button on the UI 280, and may also be stored as a reference product 278 to be used as the basis of future comparisons. Referring to FIG. 4B, the UI screen 250 can include a graphical summary of a comparison, by product component, of the life cycle greenhouse gases impact 282. The UI also includes access to the Knowledge Management system 116 via links 284.

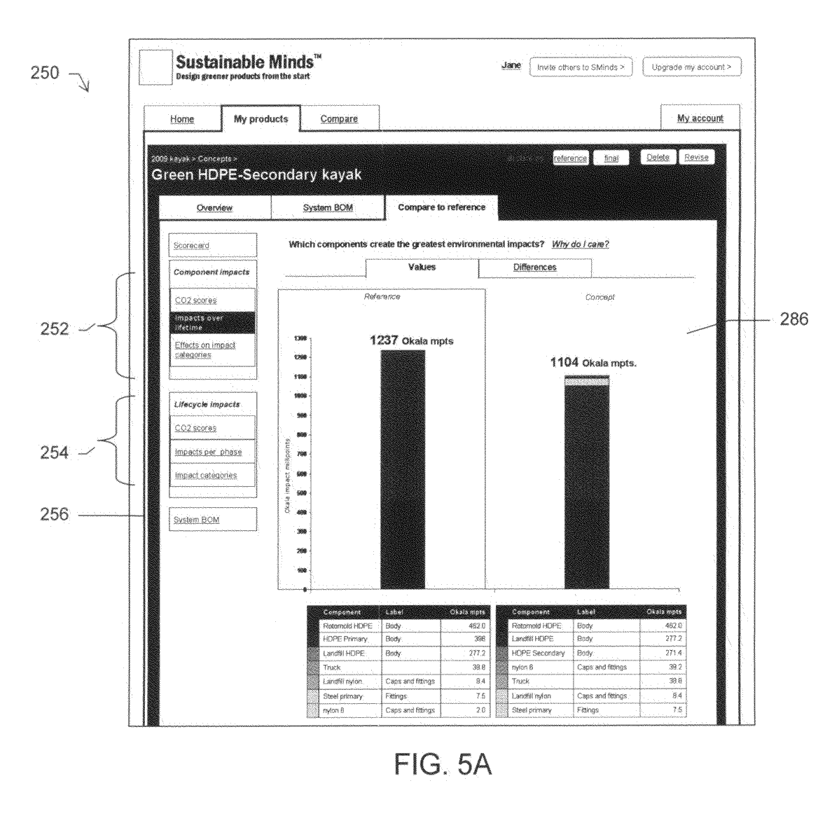

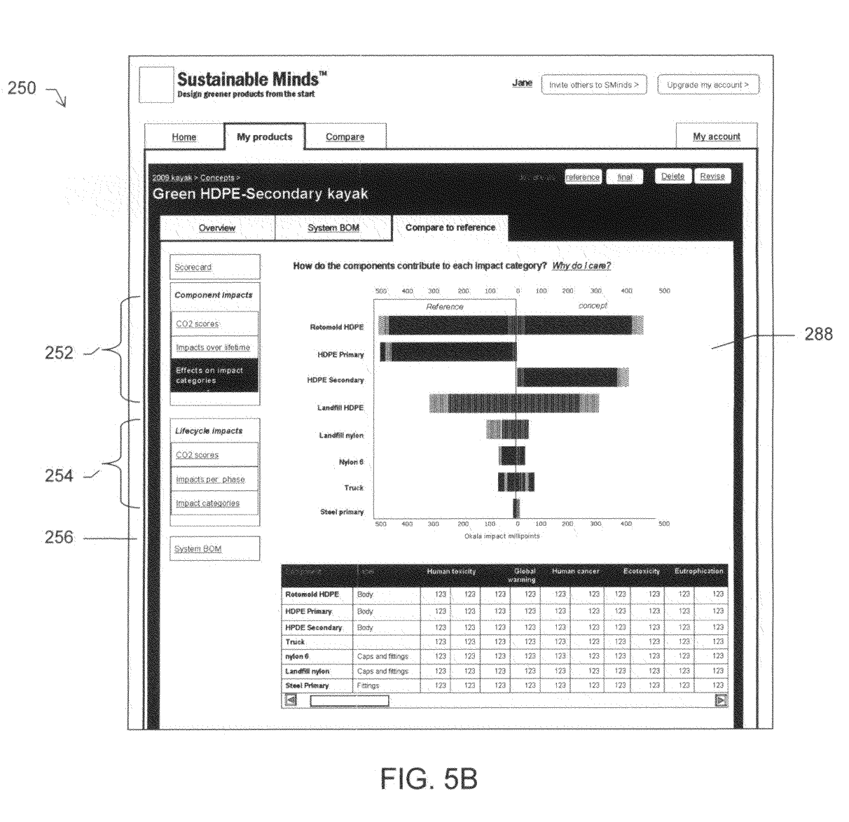

Referring to FIGS. 5A and 5B, the UI screens 250 can include a graphical representation of a comparison, by product component, of the life cycle impact results over a product lifetime with a reference product 286. In an embodiment, the life cycle impact assessment results can be measured in Okala millipoints. Other life cycle impact assessment methodologies can also be implemented and graphically displayed. The impact categories results, by product component, can also be compared to a reference product and graphically displayed 288. While FIGS. 5A and 5B provide exemplary graphs, tables and bar charts, other data presentation objects and formats can be used.

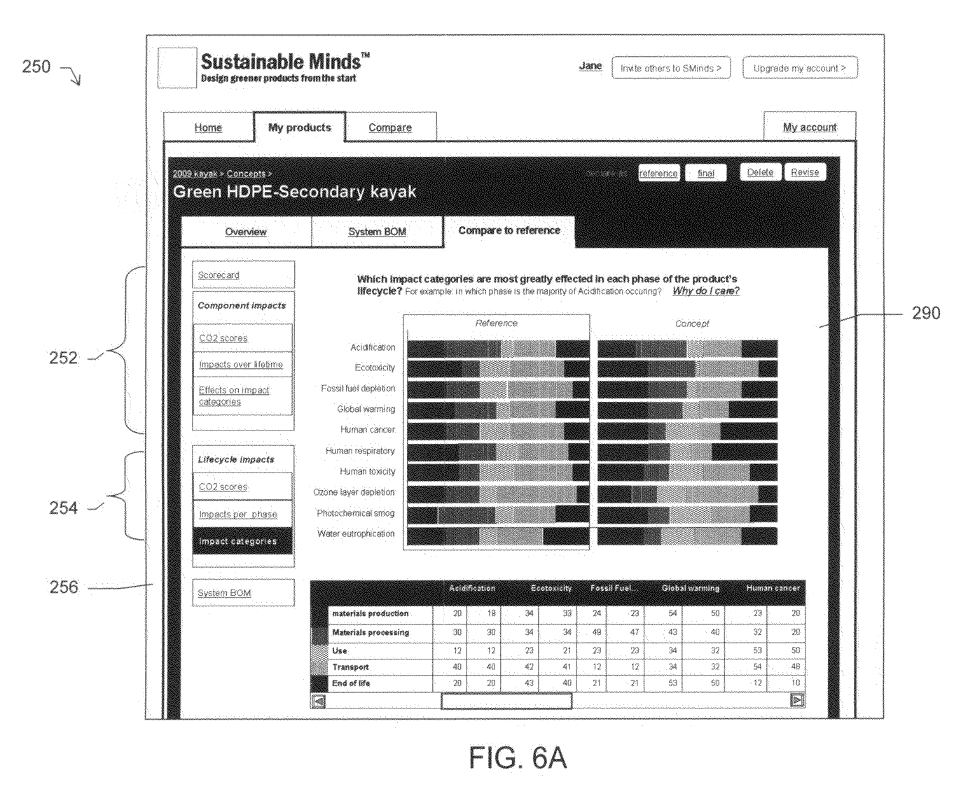

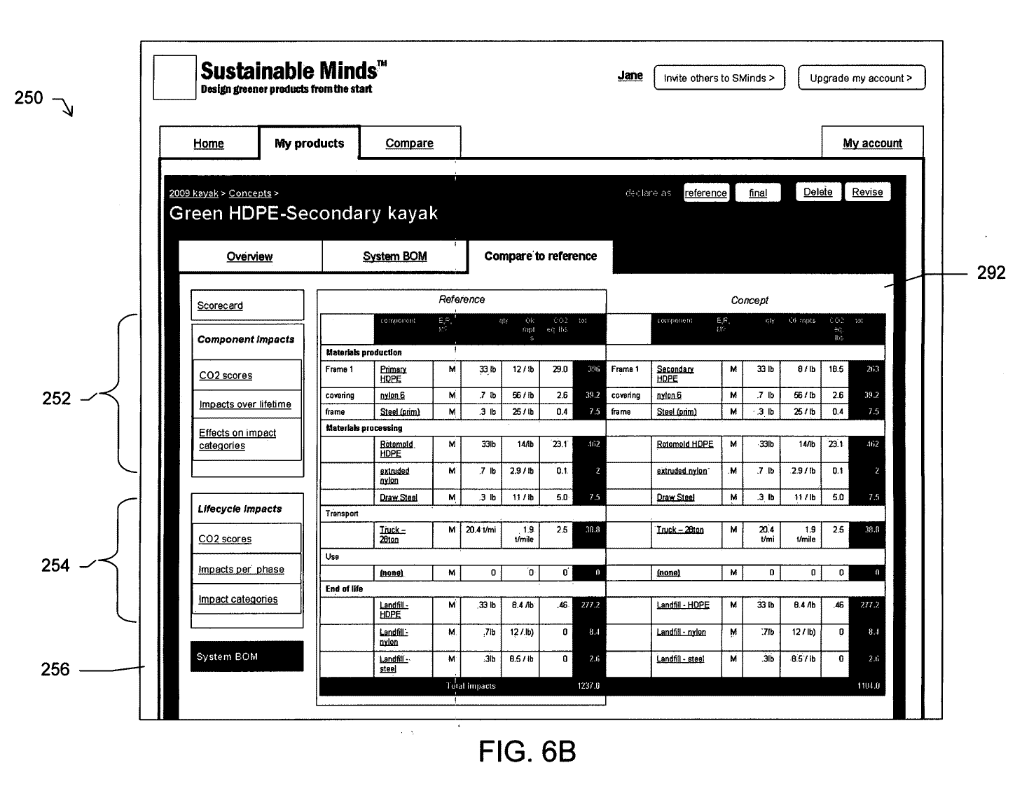

Referring to FIGS. 6A and 6B, the UI screen 250 can include a graphical representation of a comparison, by life cycle phase, of the impact categories results with a reference product 290. For example, the impact categories can include acidification, eco-toxicity, fossil fuel depletion, global warming, human cancer, human respiratory, human toxicity, ozone layer depletion, photochemical smog, water eutrophication. The life cycle phases can include materials production, material processing, use, transport, and end of life. The UI screen 250 may also compare a product System Bill of Materials data and Life Cycle Assessment results with a reference product 292.

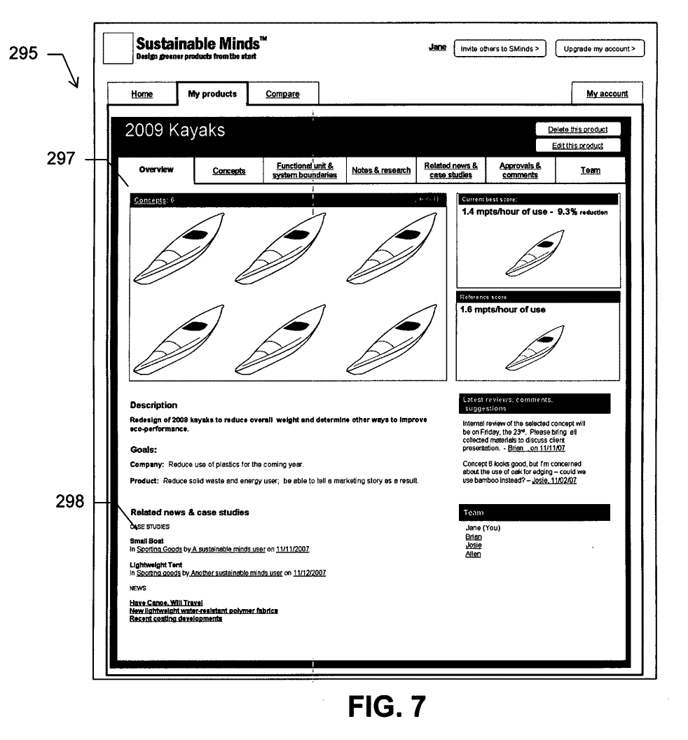

Referring to FIG. 7, an exemplary user interface 295 for a team collaborative workspace and a social network is shown. In general, the interface 295 enables team collaborative workspaces and a software-based social networking participation environment for documenting institutional and community knowledge, including discussions, file-sharing, comparisons, and versioning. The interface 295 also can provide access to related case studies, news feeds, and other general or industry-specific sustainability information can also be displayed. In an embodiment, the UI 295 can include tab objects 297 to present team concepts, functional unit and system boundaries, notes and research, related news and case studies, approvals and comments, and general team information. A case studies link section 298 can provide links into case studies stored with the knowledge management system 116.

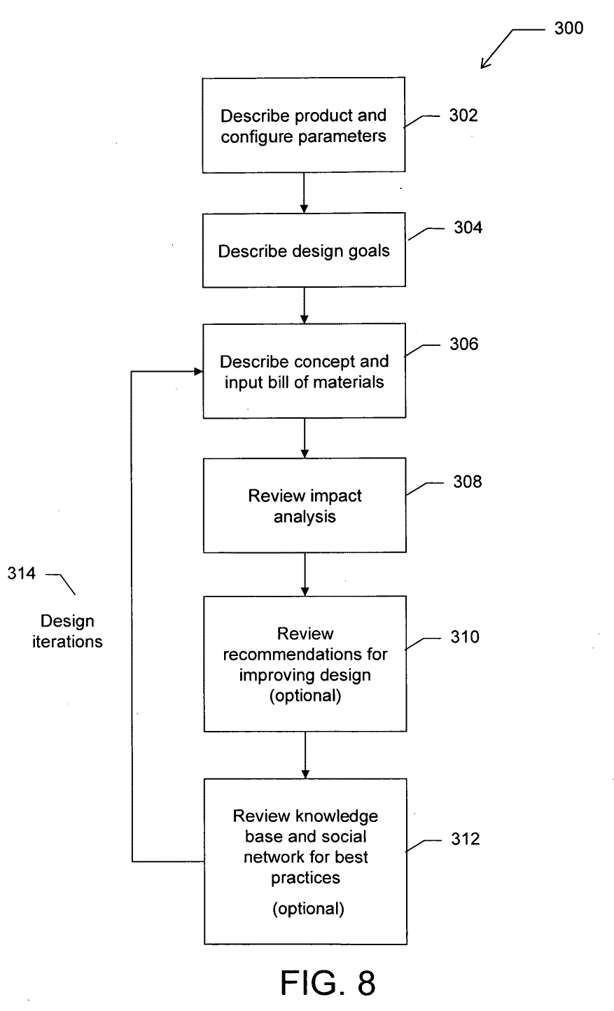

In operation, referring to FIG. 8, with further reference to FIGS. 2-7, a process 300 for designing a product using the system 100 includes the stages shown. The process 300, however, is exemplary only and not limiting. The process 300 may be altered, e.g., by having stages added, removed, or rearranged.

At stage 302, a user 102 describes a product and provides a preliminary parameter summary such as product system boundaries and functional unit. The preliminary parameter summary could also refer to other data constructs such a concept, a final concept, a reference product, a case study. For example, ‘products’ can be used to store concepts, and can allow for common parameters and criteria to be shared across concepts; ‘concepts’ can be what is actually assessed, and are generally composed primarily of the system bill-of-materials and supporting information; a ‘reference product’ can be existing products that are used for comparison to newly generated concepts; a ‘final concept’ can be a user-selected final concept. A ‘case study’ can be a collection of products including user notes such as lessons learned and results of comparisons to assessment benchmarks. The product and parameter information can be entered through the GUI 104, or via a third-party tool 106. The tool specific plug-in of 108 automatically extracts the required parameters from the third-party tool 106.

At stage 304, the user 102 describes the sustainability goals they desire. The goals include a single goal, or a plurality of goals. For example, the goals may include a CO2 footprint reduction and a total hazardous waste emission reduction. Other sustainability goals include, but are not limited to, percentage of renewable energy, removal of toxic substances, design for efficient distribution, design for assembly, design for compliance, optimized lifetime, optimizing for water and land use, biodiversity, child labor issues, community outreach and public health issues.

At stage 306, the user 102 describes a concept and inputs the bill-of-materials and additional product system information, such as transportation mode and distances and energy use estimates. The information may be entered directly through the UI 104, or could be mined from other 3^{rd} party tools 106. In an embodiment, the LCA calculator 120 or recommendation engine 124 may request further goals and parameters from the user 102 based on a subset of the information entered. Information can also be entered from case studies or other product or concept information on the system 100. For example, the knowledge management system 116 can include information on a plastic housing that was used in a previously designed cell phone. The information can be accessed based on the Okala LCA scores. In another example, the knowledge management system 116 can include LCA scored plastic housing that was assessed in previously designed cell phone. Thus, the sustainability information and assessments can be used in other projects or by other organizations.

At stage 308 the user 102 can review impact analysis performed by the LCA calculator 120. In an embodiment, for each material and process in a concept, the LCA calculator determines Okala LCA scores in different impact assessment categories and overall Okala LCA scores and displays the results in text and graphical forms. Other impact assessment methodologies as known in the art such as the Eco-Indicator 99 can be used.

At stage 310, the user 102 can review the recommendations for improving the design as provided by the logic layer 122. For example, the recommendation engine 124 can utilize the LCA calculations 120, was well as information in the social network 112, and the KM system 116 to output suggested design strategies for improving a product, such as indicating that a certain material or product generally shows a high score in global warming. The sustainable design strategy received from the recommendation engine 124 can be to reduce the amount of a certain material, to use alternative recycled or renewable materials, or to reuse materials contained in the product. In general, the design strategies can be linked to an overall goal provided by the user 102 as well as ‘weak point analysis’ of design options that user 102 can perform with the LCA calculator to identify opportunities for improvement and innovation. Other examples of design strategies can include increasing energy efficiency, and reducing material toxicity. Accordingly, based on the results of the LCA calculations 120, and the other information in the logic layer 122 and the data layer 130, the recommendation engine 124 can suggest such strategies.

At stage 312, the user 102 can view information from the logic layer 122 and data layer 130. For example, the recommendation engine 124 can output a series of links to direct the user 102 to content based on the assessment results. The user 102 may also use search engines included in the KM and social networks 112, 116 to retrieve sustainability information.

At stage 314, the user can modify the concept or product information through multiple iterations to arrive at a desired result.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A method comprising providing sustainability information and design strategies to a user in a collaborative environment over the world wide web.

2. A system for providing sustainability information and design strategies to a user, comprising:
a user interface component operative to receive a planned product design and a specified life cycle assessment methodology;
a product design assessment component operative to evaluate the planned product design based on the specified life cycle assessment methodology;
a recommendations component operative to provide at least one material to be used in the planned product design based on the results of the product design assessment; and
a product design comparison component operative to compare the results of the product design assessment with results of at least one other product design assessment.

3. The system of claim 2 comprising a knowledge management component operative to share sustainable product design information with a plurality of users.

4. The system of claim 3 wherein the knowledge management component is operative to share at least one case study.

5. The system of claim 2 wherein the recommendations component is operative to provide at least one sustainable design strategy that could be used in the planned product design based on the results of the product design assessment.

6. The system of claim 2 comprising an expert user interface component operative to receive expert information.

7. The system of 2 wherein the planned product design received from the user includes at least one material type and an amount of the material type.

8. The system of claim 3 wherein the knowledge management component is operative to share at least one product design assessment.

9. The system of claim 3 wherein the knowledge management component is operative to share at least one sustainable design strategy.

10. The system of 2 wherein the specified life cycle assessment methodology is Okala.

11. A computer-readable medium having computer-executable instructions for providing sustainability information, comprising:
maintaining a database identifying product materials and processes and their corresponding alternative materials and processes;
receiving at least one design goal from a user;
receiving a bill-of-materials including at least one product material and an amount of the at least one product material;
calculating at least one life cycle assessment result based on the at least the bill-of-materials and using at least one specified life cycle assessment methodology;
recommending at least one alternative material based on the life cycle assessment results and the bill-of-materials; and
displaying the life cycle assessment results and the at least one alternative material.

12. The computer-readable medium of claim 11 comprising;
maintaining a database of sustainable design strategy recommendations; and
displaying at least one sustainable design strategy recommendation based on the at least one design goal and the at least one life cycle assessment result.

13. The computer-readable medium of claim 11 comprising;
maintaining a database of best practices; and
displaying at least one best practice based on the at least one product material and the at least one life cycle assessment result.

14. The computer-readable medium of claim 11 comprising;
maintaining a collection of case studies; and
displaying a case study based on the at least one design goal, at least one design strategy, and the at least one life cycle assessment result.

15. The computer-readable medium of 11 wherein the life cycle assessment result is based on Okala.

16. A computer system for providing sustainability information, comprising:
at least one storage device;
at least one processor programmed to provide:
a graphic user interface configured to receive product information from a user;
a LCA calculator configured to analyze the product information and determine a life cycle assessment result;
a recommendation engine configured to analyze the product information and the life cycle assessment result, and to determine a sustainable design strategy;
a knowledge management database identifying the sustainable design strategy and a corresponding implementation note; and
a social networking system configured to display a case study on the graphic user interface based on the product information and the life cycle assessment result.

17. The computer system of claim 16 wherein the at least one processor is programmed to provide an expert user interface.

18. The computer system of claim 16 comprising a plurality of processors on a network.

19. The computer system of claim 16 wherein the at least one processor is programmed to provide a machine-to-machine programmers interface as an alternative method to the graphical user interface for obtaining product information from a user.

20. The computer system of claim 16 wherein the at least one processor is programmed to provide a machine-to-machine programmers interface as an alternative method to reporting the LCA results and recommendations from the LCA calculator, the knowledge management component and the recommendation component.

21. The computer system of claim 16 wherein the social networking system is configured to display an email address of an individual based on the product information and the life cycle assessment result.

22. The computer system of claim 16 wherein the social networking system configured to display at least one previously stored project based on the product information and the life cycle assessment result.
